(19) United States
(12) Patent Application Publication
(10) Pub. No.: US 2007/0013110 A1
(43) Pub. Date: Jan. 18, 2007

(54) Two-stage blown air system and method for foamed articles

(75) Inventor: John W. Safian, Maumee, OH (US)

Correspondence Address: VENABLE LLP, P.O. BOX 34385, WASHINGTON, DC, 20043-9998, US

(73) Assignee: GRAHAM PACKAGING COMPANY, L.P., York, PA (US)

(21) Appl. No.: 11/179,786

(22) Filed: Jul. 13, 2005

(51) Int. Cl. B29C 49/08; B29C 49/00

(52) U.S. Cl. 264/529; 425/535

(57) ABSTRACT

Two-stage blown air systems for foamed materials inject a first gas at a first pressure into the interior of a parison and then inject a second gas at a second pressure into the interior of the parison in forming a container.

### FIELD OF THE INVENTION

The present invention relates to a two-stage blown air system and method for foamed articles, which can be used as a component of a molding system. More particularly, the invention is a network including a first gas source and a second gas source for injecting a first gas at a first low pressure into the interior of a parison and for injecting a second gas at a second low pressure into the interior of the parison.

### DESCRIPTION OF THE RELATED ART

Blow molding systems can inflate a parison by pushing an injection nozzle into the parison and injecting air through the nozzle into the interior of the parison. The parison can be inflated so that the exterior surface of the parison presses against a mold wall, and the parison assumes the shape of the mold wall. Pressing the parison exterior surface against the mold wall can facilitate cooling of the parison through conduction of heat from the parison through the mold. It can be useful to use a high pressure to inflate the parison, so that the parison exterior surface presses firmly against the mold wall and assumes the shape of features of the mold wall, so that the resultant product, for example, a container, has these features. It is thought that pressing the parison exterior surface firmly against the mold wall can improve the rate of cooling and the uniformity of temperature throughout the parison.

It can be desirable for many applications to produce an article, such as a container, that is both light in weight and strong. An article that is light in weight and strong can be formed of, for example, a foamed material, such as a foamed polymer. For example, in the process of blowing a container, such as a bottle, a parison can include a foamed material. Using a foamed material to produce a container can be advantageous in that, for example, the container can have the required strength with less material than a container not using a foamed material, so that material costs are reduced.

In a foamed material, gas can be present in cells fully or partially bounded by a solid or semisolid material, such as a polymer. For example, in an open-cell foam, the cells are interconnected. By contrast, in a closed-cell foam, the cells are isolated from each other by the surrounding material. A foamed polymer can be formed by, for example, including a chemical additive in a batch of polymer resin that is melted in an extruder. The chemical additive can react or decompose through an endothermic or exothermic process to release a gas that expands to form bubbles which can form the cells upon cooling. Alternatively, a foamed polymer can be formed by including polymer capsules that enclose a gas, for example, “microspheres,” in a batch of polymer resin. When the polymer capsules are heated, the shell of a polymer capsule can soften so that the gas in the interior of the capsule can expand; the expanded interiors of the capsules can form the cells upon cooling.

When a parison including a foamed material is blown under high pressure, for example, under a pressure greater than 80 psig in a continuous extrusion process, so as to force the parison against the mold wall, the pressure can act to reduce the volume of the cells. The reduction in the volume of the cells can lead to an increase in the density of the foamed material and to a reduction in the strength of a container formed from a given mass of foamed material. Therefore, when cells in a foamed material are unduly compressed in a blow process, the amount of material necessary to produce a container of required strength can be similar to the amount necessary when a non-foamed material is used.

In order to not unduly compress the cells in a foamed material used, for example, in blowing a parison to form a container, a low pressure can be applied to the parison. However, blowing the parison with a low pressure can result in the parison not expanding completely in the mold, so that the resultant container does not have a predetermined, desired shape. For example, blowing the parison with a low pressure can result in the parison not expanding completely in the mold within an acceptable time given the allowable blow cycle time.

There thus remains an unmet need for a blown air system and method that allow for the control of the density of a foamed material, and that allow articles of a predetermined shape to be formed.

### SUMMARY OF THE INVENTION

It is therefore an object of the present invention to provide novel blown air systems and methods that allow for the control of the density of a foamed material, and that allow articles of a predetermined shape to be formed.

A method of the present invention includes providing a parison having a parison interior, firstly injecting a first gas at a first pressure into the parison interior, and secondly injecting a second gas at a second pressure into the parison interior to form a container. The parison can include a foamed material.

A method of the present invention includes forming a plurality of containers. Each container can be formed in a cycle including providing a parison having a parison interior, firstly injecting a first gas at a first pressure into the parison interior for a first predetermined period of time, and secondly injecting a second gas at a second pressure into the parison interior for a second predetermined period of time to form a container. The parison can include a foamed material.

An embodiment of a two-stage blown air system for blow molding a container from a parison includes an injection nozzle, a first gas source of a first gas at a first pressure, a second gas source of a second gas at a second pressure, a multi-way valve, and a mold having a mold wall. The multi-way valve can include a common port, a first supply port, and a second supply port. The common port can be fluidly coupled to the injection nozzle; the first supply port can be fluidly coupled to the first gas source; and the second supply port can be fluidly coupled to the second gas source.

### BRIEF DESCRIPTION OF THE DRAWINGS

FIG. 1 is a schematic of an embodiment of a blow air control system according to the present invention.

FIG. 2 is a cross-sectional view of a portion of an embodiment of a blow air control system according to the present invention.

FIG. 3 is a schematic of an embodiment of a blow air control system according to the present invention.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent parts can be employed and other methods developed without parting from the spirit and scope of the invention. All references cited herein are incorporated by reference as if each had been individually incorporated.

In order to produce an article, for example, a container, of a predetermined shape without unduly compressing cells in a foamed material, for example, a foamed polymer, of which the article is formed, and without increasing the density of the foamed material above a predetermined value, a two-stage blowing process can be used. That is, a first low pressure can be applied to the interior of a parison and then a second low pressure can be applied to the interior of the parison. The first pressure can be lower than a pressure applied to the interior of a parison in a conventional blow process. The first pressure can be maintained for a first predetermined period of time; the first predetermined period of time can be shorter than the time for which pressure is applied to the interior of a parison in a conventional blow process. For example, a first low pressure can be firstly applied to the parison in order to expand the parison so that the exterior surface of the parison conforms to a mold wall within an acceptable time given the allowable blow cycle time. A second pressure can be secondly applied to the parison in order to gently press and hold the parison against the mold wall, so that the parison can cool without substantial compression of the cells in the foamed material. The second pressure can be even lower than the first pressure. The second pressure can be maintained for a second predetermined period of time; the second pressure can be maintained for the remainder of the blow cycle. The resultant container can have the desired, predetermined shape, and the foamed material of the container can have the desired density.

The first pressure can be firstly applied to the parison in order to expand the parison so that the exterior surface of the parison is near to a mold wall within an acceptable time given the allowable blow cycle time. The second pressure can be secondly applied to the parison in order to gently press the parison against the mold wall, so that the parison conforms to the shape of the mold wall without unduly compressing cells in the foamed material, and without increasing the density of the foamed material above a predetermined value. The second pressure can be even lower than the first pressure. The second pressure can be maintained for the remainder of the blow cycle. The resultant container can have the desired, predetermined shape, and the foamed material of the container can have the desired density. The second pressure can be applied both to have the parison conform to the mold wall and to hold the parison against the mold wall during cooling.

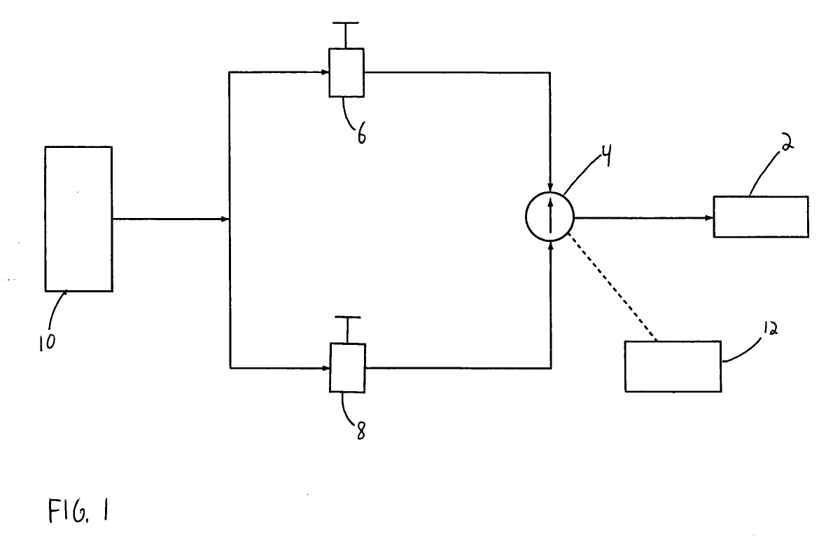

An embodiment of a two-stage blown air system for foamed articles can include the following, as shown in FIG. 1. An injection nozzle 2 can inject a gas into the interior of a parison. A multi-way valve 4 can include a common port, a first supply port, and a second supply port. The multi-way valve 4 can be a three-way valve, as shown in FIG. 1. Or the multi-way valve can have more than three ports; for example, the multi-way valve can be a four-way valve, a five-way valve, and so forth. The common port of the multi-way valve 4 can be fluidly coupled to the injection nozzle 2. The first supply port can be fluidly coupled to a first gas source of a first gas at a first pressure. The second supply port can be fluidly coupled to a second gas source of a second gas at a second pressure. The system can further include a mold having a mold wall, not shown in FIG. 1. The second pressure can be lesser than or equal to the first pressure. The first gas can have the same or a different chemical composition as the first gas. The first gas can be, for example, air, nitrogen, carbon dioxide, or another gas; the second gas can be, for example, air, nitrogen, carbon dioxide, or another gas.

The second gas source can include a second gas pressure regulator 8, and the second gas pressure regulator 8 can be fluidly coupled to the multi-way valve 4. The second gas pressure regulator 8 and the first gas source can be for fluidly coupling to a main gas source 10. The first gas source can include a first gas pressure regulator 6. The first gas pressure regulator 6 can be fluidly coupled to the multi-way valve 4, and can be for fluidly coupling to the main gas source 10.

In certain cases, for example, when certain foamed materials or mold geometries are used, the minimum first pressure and/or the minimum second pressure required for the parison to conform to the shape of the mold wall may be greater than the maximum first pressure and/or the maximum second pressure allowable for the foamed material to have a predetermined density. In such a case, a vacuum can be applied at the mold wall in order to move the parison toward and to have the parison conform to the mold wall. Thus, the vacuum can ensure that the parison assumes the desired predetermined shape, and the firm contact of the parison with the mold wall induced by the vacuum can promote cooling of the parison. The first pressure can act to move the exterior surface of the parison near to the mold wall where the vacuum is present, and the effect of the vacuum can then move the parison to conform with the mold wall. By using the vacuum, undue compression of the cells in the foamed material and an increase in density of the foamed material above an acceptable value can be avoided.

The second pressure can be applied, for example, to move the exterior surface of the parison to a position where the vacuum is present and the effect of the vacuum can then move the parison to conform with the mold wall, to work together with the vacuum to move the parison to conform with the mold wall, and/or to work together with the vacuum to hold the parison against the mold wall during cooling. The second pressure applied to the interior of the parison can be lower than the first pressure and can be very low; in terms of absolute pressure, the second pressure can even be ambient pressure or less than ambient pressure.

The vacuum can induce expansion of the cells in the foamed material. The first pressure and/or the second pressure can be adjusted to control the expansion of the cells or to prevent expansion of the cells during the blow process. The duration for which the parison is exposed to the vacuum can be adjusted to control expansion of the cells in the foamed material: a longer exposure of the parison to the vacuum can result in greater expansion of the cells; a shorter exposure of the parison to the vacuum can result in lesser expansion of the cells.

An operator can adjust the first pressure, a first predetermined period of time for which the first pressure is applied, the second pressure, a second predetermined period of time for which the second pressure is applied, the vacuum pressure (the vacuum pressure is less than ambient pressure), and/or the period for which the vacuum is applied. By adjusting these parameters, the operator can control the compression of the cells in the foamed material and can control the density of the foamed material in an article, for example, a container. The operator can control these parameters to, for example, bring product characteristics, such as density, within specifications in the beginning part of a production run, and/or to correct for variation during a production run in the characteristics of a polymer resin used in forming articles.

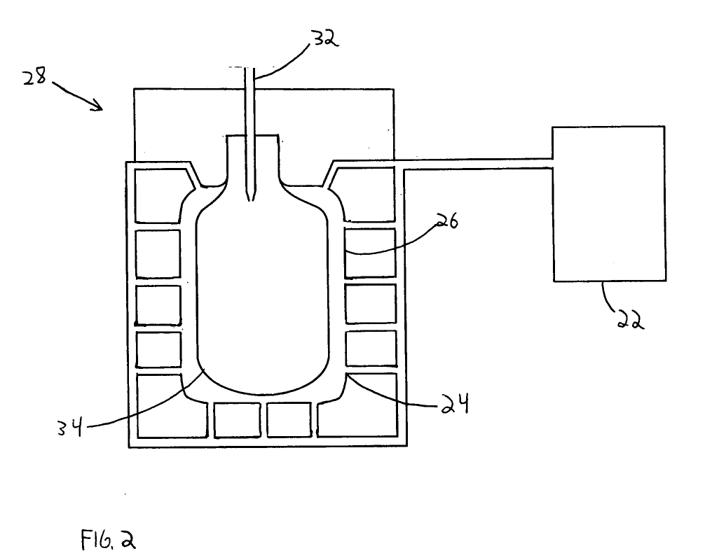

FIG. 2 illustrates a mold 28 having a mold wall 26. The mold 28 can close to enclose a parison 34, for example, a parison 34 of molten or soft plastic. The parison 34 can be blown by an injection nozzle 32. The mold wall 26 can include mold wall openings 24, and these mold wall openings 24 can be coupled to a vacuum source 22. Thus, a vacuum can be applied at the mold wall 26 through the mold wall openings 24. The mold wall openings 24 can include, for example, holes and/or slits. The vacuum source 22 can include a vacuum control source to turn the vacuum on and off, and/or to adjust the vacuum pressure, for example, from slightly below ambient pressure to full vacuum. For example, the vacuum can be turned off when the first gas at the first pressure is injected into the parison, and the vacuum can be turned on when the second gas at the second pressure is injected into the parison.

The system can further include a heat source, not shown in FIG. 2. The mold wall 26 can be coupled to the heat source.

The system can include a timer 12, shown in FIG. 1, coupled to the multi-way valve 4, for triggering the multi-way valve 4 to inject the first gas at the first pressure through the injection nozzle 2 for a first predetermined period of time. The timer 12 can trigger the multi-way valve 4 to inject the second gas at the second pressure through the injection nozzle 2 for a second predetermined period of time. The timer 12 can include a first predetermined period of time set adjust and/or a second predetermined period of time set adjust. The timer 12 can trigger the vacuum source 22 to provide vacuum to the mold wall 26 for a period.

For example, the timer 12 can be an electronic or an electrical timer. The timer 12 can trigger the multi-way valve 4 to inject the first gas at the first pressure by, for example, transmitting an electrical impulse to a solenoid, so that the solenoid then switches the multi-way valve 4 to fluidly couple the first supply port to the common port. The timer 12 can trigger the multi-way valve 4 to inject the second gas at the second pressure by, for example, transmitting an electrical impulse to a solenoid, so that the solenoid then switches the multi-way valve 4 to fluidly couple the second supply port to the common port.

For example, the timer 12 can be a mechanical timer or another type of timer. For example, the timer 12 can include a cam, for example, a cam associated with a molding apparatus wheel. The timer 12 can trigger the multi-way valve 4 to inject the first gas at the first pressure by, for example, imposing a mechanical force on the multi-way valve 4 to fluidly couple the first supply port to the common port. The timer 12 can trigger the multi-way valve 4 to inject the second gas at the second pressure by, for example, imposing a mechanical force on the multi-way valve 4 to fluidly couple the second supply port to the common port.

The system can include a computer. The computer can be coupled to the multi-way valve 4, and can trigger the multi-way valve 4 to inject the first gas at the first pressure through the injection nozzle 2 for a first predetermined period of time, and can trigger the multi-way valve 4 to inject the second gas at the second pressure through the injection nozzle 2 for a second predetermined period of time. The computer can be coupled to the vacuum source 22, and can trigger the vacuum source 22 to provide vacuum to the mold wall 26 for a period. The computer can be coupled to the first gas pressure regulator 6 for adjusting the first gas pressure regulator to the first pressure, and the computer can be coupled to the second gas pressure regulator 8 for adjusting the second gas pressure regulator 8 to the second pressure. The computer can be coupled to the vacuum source 22 for adjusting the vacuum source 22 to a vacuum pressure (the vacuum pressure is less than ambient pressure). A user can adjust the computer to set the first predetermined period of time, set the first pressure, set the second predetermined period of time, set the second pressure, set the period for which vacuum is provided to the mold wall 26, and/or set the vacuum pressure.

The computer can be an electronic computer, for example, the computer can include a microprocessor. For example, the computer can be a personal computer. Alternatively, the computer can be a digital electronic special purpose controller. Alternatively, the computer can be an analog electronic system. The computer can trigger the multi-way valve 4 to inject the first gas at the first pressure by, for example, transmitting an electrical impulse to a solenoid, so that the solenoid then switches the multi-way valve 4 to fluidly couple the first supply port to the common port. The computer can trigger the multi-way valve 4 to inject the second gas at the second pressure by, for example, transmitting an electrical impulse to a solenoid, so that the solenoid then switches the multi-way valve 4 to fluidly couple the second supply port to the common port. The computer can adjust the first gas pressure regulator by, for example, transmitting an electrical impulse to a solenoid, so that the solenoid then adjusts the first gas pressure regulator 6 to set the first gas pressure regulator 6 to the first pressure. The computer can adjust the second gas pressure regulator 8 by, for example, transmitting an electrical impulse to a solenoid, so that the solenoid then adjusts the second gas pressure regulator 8 to set the second gas pressure regulator 8 to the second pressure.

The computer can be a mechanical system, for example, a system including a cam or cams associated with a molding apparatus wheel. The computer can trigger the multi-way valve 4 to inject the first gas at the first pressure by, for example, imposing a mechanical force on the multi-way valve 4 to fluidly couple the first supply port to the common port. The computer can trigger the multi-way valve 4 to inject the second gas at the second pressure by, for example, imposing a mechanical force on the multi-way valve 4 to fluidly couple the second supply port to the common port. The computer can adjust the first gas pressure regulator by, for example, imposing a mechanical force on the first gas pressure regulator 6 to set the first gas pressure regulator 6 to the first pressure. The computer can adjust the second gas pressure regulator 8 by, for example, imposing a mechanical force on the second gas pressure regulator 8 to set the second gas pressure regulator 8 to the second pressure.

The computer can be programmed to implement a complex schedule, for example, a schedule in which the first predetermined period of time, the second predetermined period of time, the first pressure, and/or the second pressure vary from molding cycle to molding cycle, or from a set of molding cycles to another set of molding cycles. The implementation of such a complex schedule can be useful, for example, when an operator desires to firstly use the molding apparatus to blow a first set of containers made from a first material, and then to secondly use the molding apparatus to blow a second set of containers made from a second material.

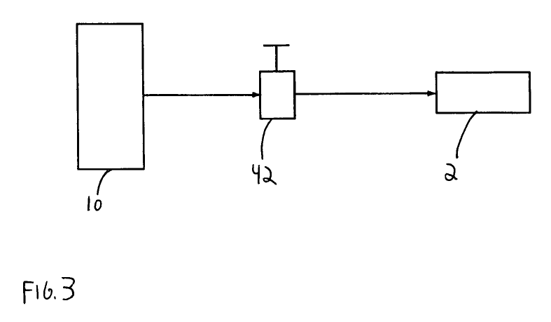

An alternative embodiment of a two-stage blown air system for foamed articles can include the following, as shown in FIG. 3. An injection nozzle 2 can be fluidly coupled to a gas pressure regulator 42. The gas pressure regulator 42 can be for fluidly coupling to a main gas source 10. The gas pressure regulator 42 can be capable of adjusting gas pressure to a first pressure and to a second pressure. The two-stage blown air system can further include a mold 28 having a mold wall 26 (see FIG. 2). The second pressure can be lesser than or equal to the first pressure.

A method can include providing a parison 34 having a parison interior, firstly injecting a first gas at a first pressure into the parison interior, and secondly injecting a second gas at a second pressure into the parison interior to form a container. The parison can include a foamed material; the foamed material can include gas-filled hollow microspheres. The second pressure can be lesser than or equal to the first pressure.

The method can include drawing a vacuum at a mold wall 26 to pull the parison onto the mold wall 26. The mold wall 26, surrounding the parison 34, can be heated.

The first gas can be injected at the first pressure for a first predetermined period of time. This first predetermined period of time can be, for example, in a range of from about 10% to about 20% of the total blow cycle time. The second gas can be injected at the second pressure for a second predetermined period of time.

The first pressure can be in a range of from about 15 psig to about 40 psig, and the second pressure can be less than about 20 psig. For example, the first pressure can be about 20 psig and the second pressure can be about 10 psig. The abbreviation “psig” stands for “pounds per square inch gauge”, that is, the value of the absolute pressure minus the ambient pressure. The first pressure and the second pressure can be adjusted, for example, to control the density of the foamed material in the container resulting from the blow process. That is, a lower first pressure and/or a lower second pressure can be used to achieve a lower density foam; a higher first pressure and/or a higher second pressure can be used to achieve a higher density foam.

A method can include forming a plurality of containers. Each container can be formed in a cycle in which a first gas is firstly injected at a first pressure into the interior of a parison 34 for a first predetermined period of time, and in which a second gas is secondly injected at a second pressure into the parison interior for a second predetermined period of time to form a container; the parison 34 can include a foamed material. The first pressure and/or the second pressure can vary between at least two cycles. The first predetermined period of time and/or the second predetermined period of time can vary between at least two cycles.

### EXAMPLE

Table 1 presents conditions and results for several experimental runs.

TABLE 1
SUMMARY OF FOAM ADDITIVES (CBA used)
16 oz oval used

| | Blow Settings | | | Ave Wall | |
|---|---|---|---|---|---|
| | 1 psi-1 time- | | | Thickness | Density |
| | 2 psi-2 time | LDR % | G.W. | (ths) | (G/cc) |
| CONTROL | 50 psi @ 7 sec | 0 | 32.9 | 31.5 | 0.952 |
| VAR 2 | 50-1-10-6 | 1 | 31.7 | 29.9 | 0.877 |
| VAR 3 | 30-1-10-6 | 1 | 32.7 | 36.8 | 0.823 |
| VAR 4 | 20-1-10-6 | 1 | 30.2 | 33.7 | 0.833 |
| VAR 5 | 15-1-5-6 | 1 | 30.3 | 38.7 | 0.769 |
| VAR 6 | 50-1-10-6 | 1.5 | 26.9 | 29.7 | 0.769 |
| VAR 7 | 30-1-10-6 | 1.5 | 28 | 34.9 | 0.769 |
| VAR 8 | 20-2-10-6 | 1.5 | 27.4 | 33.3 | 0.769 |
| VAR 9 | 15-1-10-6 | 1.5 | 26.7 | 34.8 | 0.678 |

Note:
Control samples were blow with straight blow, no 2 stage function
Variables 2 thru 9:2 stage blow with vacuum was used.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A method, comprising:
firstly injecting a first gas at a first pressure into a parison interior of a parison; and
secondly injecting a second gas at a second pressure into the parison interior to form a container,
wherein the parison comprises a foamed material.

2. The method of claim 1, wherein the second pressure is lesser than or equal to the first pressure.

3. The method of claim 1, further comprising drawing a vacuum at a mold wall to pull the parison onto the mold wall.

4. The method of claim 1, further comprising heating a mold wall surrounding the parison.

5. The method of claim 1, wherein the foamed material comprises polymer capsules that enclose a gas.

6. The method of claim 1, wherein the first gas is injected at the first pressure for a first predetermined period of time.

7. The method of claim 6, wherein the first predetermined period of time is in a range of from about 10% to about 20% of the total blow cycle time.

8. The method of claim 1, wherein the second gas is injected at the second pressure for a second predetermined period of time.

9. The method of claim 1, wherein the first pressure is in a range of from about 15 psig to about 40 psig and the second pressure is less than about 20 psig.

10. The method of claim 9, wherein the first pressure is about 20 psig and the second pressure is about 10 psig.

11. The method of claim 1, wherein the first gas and the second gas are air.

12. A method, comprising forming a plurality of containers, each container formed in a cycle comprising the method of claim 6,
wherein the second gas is injected at the second pressure for a second predetermined period of time.

13. The method of claim 12, wherein at least one of the first pressure and the second pressure varies between at least two cycles.

14. The method of claim 12, wherein at least one of the first predetermined period of time and the second predetermined period of time varies between at least two cycles.

15. A two-stage blown air system, comprising:
an injection nozzle;
a first gas source of a first gas at a first pressure;
a second gas source of a second gas at a second pressure;
a multi-way valve, comprising a common port, a first supply port, and a second supply port;
the common port fluidly coupled to the injection nozzle;
the first supply port fluidly coupled to the first gas source;
the second supply port fluidly coupled to the second gas source; and
a mold having a mold wall.

16. The system of claim 15, wherein the second pressure is lesser than or equal to the first pressure.

17. The system of claim 15, wherein the second gas source comprises a second gas pressure regulator, the second gas pressure regulator is fluidly coupled to the multi-way valve, and the second gas pressure regulator and the first gas source are for fluidly coupling to a main gas source.

18. The system of claim 15, wherein the first gas source comprises a first gas pressure regulator, the second gas source comprises a second gas pressure regulator, the first gas pressure regulator is fluidly coupled to the multi-way valve, the second gas pressure regulator is fluidly coupled to the multi-way valve, and the first gas pressure regulator and the second gas pressure regulator are for fluidly coupling to a main gas source.

19. The system of claim 15, further comprising a vacuum source,
wherein the mold wall comprises mold wall openings and the mold wall openings are coupled to the vacuum source.

20. The system of claim 15, further comprising a heat source,
wherein the mold wall is coupled to the heat source.

21. The system of claim 15, further comprising a timer coupled to the multi-way valve, for triggering the multi-way valve to inject the first gas at the first pressure through the injection nozzle for a first predetermined period of time and for triggering the multi-way valve to inject the second gas at the second pressure through the injection nozzle for a second predetermined period of time.

22. The system of claim 21, the timer comprising a first predetermined period of time set adjust and a second predetermined period of time set adjust.

23. The system of claim 18, further comprising:
a computer;
the computer coupled to the multi-way valve, for triggering the multi-way valve to inject the first gas at the first pressure through the injection nozzle for a first predetermined period of time and for triggering the multi-way valve to inject the second gas at the second pressure through the injection nozzle for a second predetermined period of time;
the computer coupled to the first gas pressure regulator for adjusting the first gas pressure regulator to the first pressure; and
the computer coupled to the second gas pressure regulator for adjusting the second gas pressure regulator to the second pressure,
wherein a user can adjust the computer to set at least one of the first predetermined period of time, the first pressure, the second predetermined period of time, and the second pressure.
